(19) United States
(12) Patent Application Publication
(10) Pub. No.: US 2015/0319585 A1
(43) Pub. Date: Nov. 5, 2015

(54) METHOD, SYSTEM AND DEVICE FOR CONTROLLED TALK PRIVILEGE IN A PUSH TO TALK COMMUNICATION SESSION

(71) Applicant: MOTOROLA SOLUTIONS, INC., SCHAUMBURG, IL (US)

(72) Inventor: TINA RAJ, BANGALORE (IN)

(73) Assignee: MOTOROLA SOLUTIONS, INC., SCHAUMBURG, IL (US)

(21) Appl. No.: 14/269,861

(22) Filed: May 5, 2014

(51) Int. Cl. H04W 4/10; H04L 29/06; H04W 12/08; H04W 76/00

(52) U.S. Cl. CPC H04W 4/10; H04W 76/005; H04L 65/4061; H04W 12/08

(57) ABSTRACT

A method, system and device for providing controlled talk privilege in a PTT group communication session involving a PTT group. The method includes assigning, at a PTT server, a listener privilege to a first member and a speaker privilege to second member. Speaker privilege is a necessary but not sufficient requirement for floor control of the PTT group. An authorisation request from the first member is received, at the PTT server, for a speaker privilege. The authorisation request from the first member is processed, at the PTT server, to determine whether speaker privilege is to be assigned to the first member. In response to an acceptance of the first member's authorisation request for speaker privilege, the method subsequently includes assigning, at the PTT server, a speaker privilege to the first member.

### BACKGROUND OF THE INVENTION

For many decades, half duplex two way radio networks have provided reliable and convenient communications using limited, shared radio resources. For example, “walkie-talkie” and citizens band (CB) radio networks have enabled users to maintain direct communication channels with other users over extended periods of time. The push-to-talk (PTT) and “instant on” features of half duplex radio devices provide desirable modes of wireless communication for users such as truckers, construction and industrial site personnel, military personnel, taxi dispatchers, police and fire personnel and numerous others.

Many modern communications systems designed for public safety still typically allocate only one logical media stream in a network, which is shared among network members. A floor control mechanism then dictates which device in the network is permitted to send media at a given time on a given stream.

Push-to-talk over cellular (PoC) is a recent technology that enables familiar PTT and “instant on” features of conventional half duplex radios, but uses mobile communication devices operating over modern cellular telecommunications networks. Using PoC, wireless communication devices such as mobile telephones and notebook computers can therefore function as PTT half-duplex radio devices for transmitting and receiving voice and/or data. Other types of PTT models and multimedia call models (MMCMs) are also available.

Floor control in a PTT session is generally maintained by a PTT server that controls communications between two or more wireless communication devices. However, in PTT group communication sessions with large talk groups (e.g., groups including thousands of members) administering of floor control can become difficult when all members are allowed to request floor control.

Accordingly, there is a need for a method, system and device for providing controlled talk privilege in a PTT group communication session involving a PTT group.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram illustrating elements of a wireless communication network, in accordance with some embodiments.

FIG. 2 is a flow diagram of a method for controlled talk privilege in a PTT group communication session involving a PTT group, in accordance with some embodiments.

FIG. 3 is a device for controlled talk privilege in a PTT group communication session involving a PTT group, in accordance with some embodiments.

FIG. 4 is a flow diagram illustrating a further method for controlled talk privilege in a PTT group communication session involving a PTT group, according to some embodiments

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

According to some embodiments of the present invention, a method enables controlled talk privilege in a push to talk (PTT) group communication session involving a PTT group. The method includes assigning, at a PTT server, a listener privilege to a first member of the PTT group, wherein the listener privilege allows the first member to listen-only in the PTT group communication session. The method also includes assigning, at the PTT server, a speaker privilege to a second member of the PTT group, wherein the speaker privilege allows the second member to listen and speak in the PTT group communication session and to receive requests for speaker privilege from members with a listener privilege, and wherein the speaker privilege is a necessary but not sufficient requirement for floor control of the PTT group. As part of the method, an authorisation request from the first member is received, at the PTT server, for a speaker privilege. Next, processing of the authorisation request from the first member is undertaken, at the PTT server, to determine whether speaker privilege is to be assigned to the first member. In response to an acceptance of the first member's authorisation request for speaker privilege, the method subsequently includes assigning, at the PTT server, a speaker privilege to the first member.

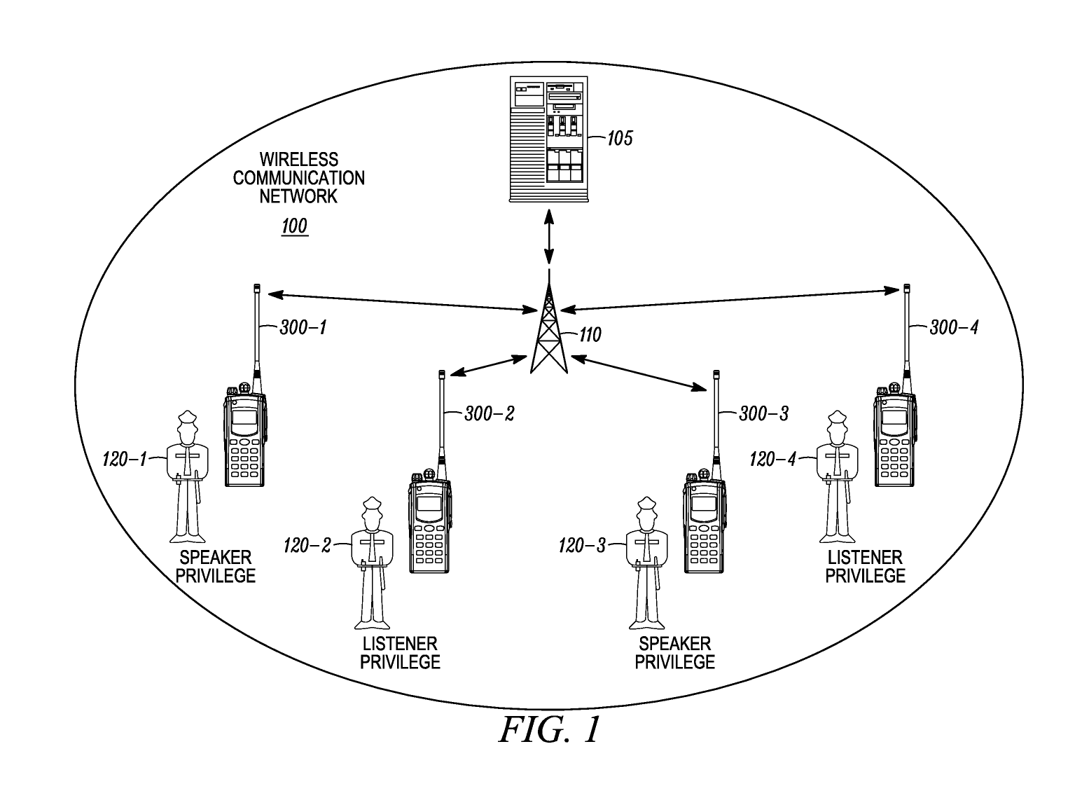

Referring to FIG. 1, a network diagram illustrates elements of a wireless communication network 100, according to some embodiments of the present invention. The wireless communication network 100 includes a PTT server 105, a routing apparatus including a base station 110, and PTT devices 300-n (depicted in FIG. 1 as PTT devices 300-1, 300-2, 300-3, and 300-4).

The PTT server 105 comprises a random access memory and a programmable memory that are coupled to a processor. The processor also has ports for coupling to network interfaces. The PTT devices 300-n are discussed further below.

Each member 120-n (depicted in FIG. 1 as members 120-1, 120-2, 120-3, and 120-4) of a PTT group is associated with a corresponding PTT device 300-n for a PTT group communication session (such that, for example, member 120-1 operates PTT device 300-1, member 120-2 operates PTT device 300-2, etc.). Each member 120-n and their associated PTT device 300-n is assigned with either a speaker privilege or a listener privilege for the PTT group communication session, as further outlined below.

Wireless communication devices and network devices, such as the radio devices 300-n and the PTT server 105, that implement embodiments of the present invention can utilise various types of wireless network architectures including a mesh enabled architecture (MEA) network, or an Institute of Electrical and Electronics Engineers (IEEE) 802.11 network (e.g. 802.1 Ia, 802.1 Ib, 802.1 Ig, 802.1 In). (Note: for any IEEE standards recited herein, see: http://standards.ieee.org/getieee802/index.html or contact the IEEE at IEEE, 445 Hoes Lane, PO Box 1331, Piscataway, N.J. 08855-1331, USA.) It will be appreciated by those of ordinary skill in the art that such wireless communication networks can alternatively comprise any packetized communication network where packets are forwarded across multiple wireless hops. For example, such a wireless communication network can be a network utilizing multiple access schemes such as orthogonal frequency division multiple access (OFDMA), time division multiple access (TDMA), frequency division multiple access (FDMA), or carrier sense multiple access (CSMA).

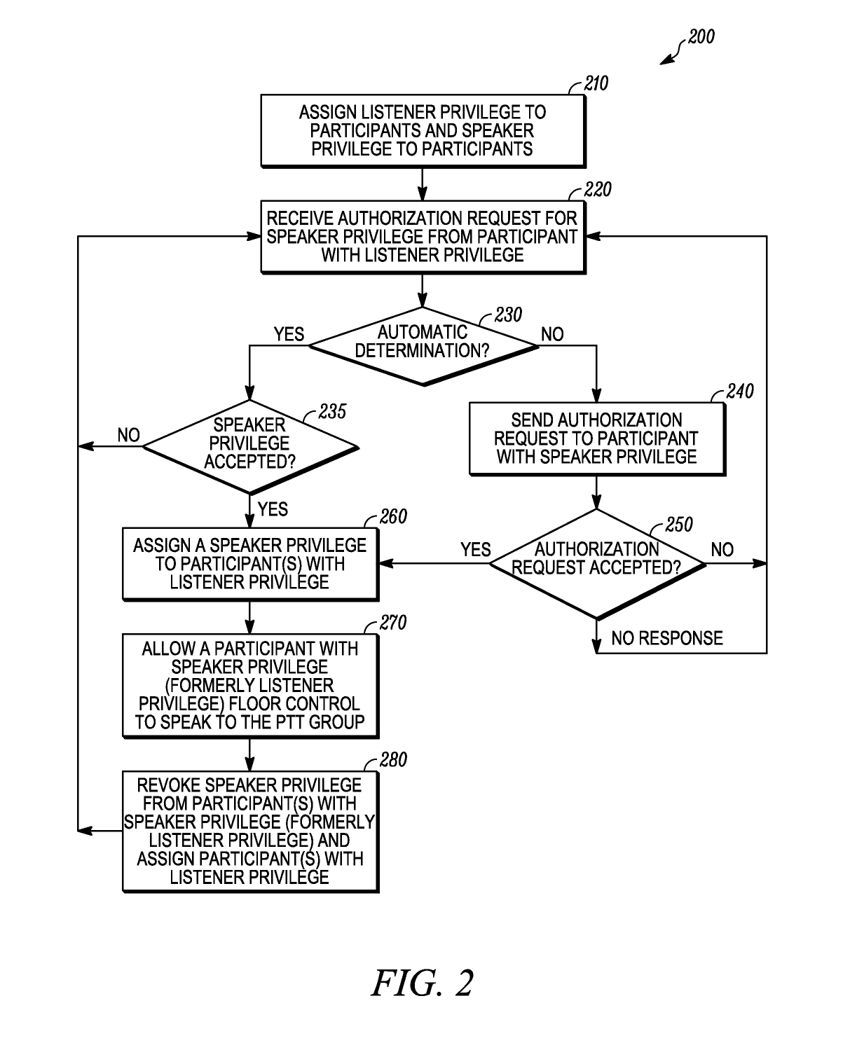

FIG. 2 is a flow diagram of a method 200 for controlled talk privilege in a PTT group communication session involving a PTT group, in accordance with some embodiments. At block 210, the members 120-n are assigned at the PTT server 105 with listener privilege or speaker privilege, according to the privilege outlined in FIG. 1. That is, members 120-1 and 120-3 and their associated PTT devices 300-1 and 300-3, respectively, are assigned with speaker privilege at the PTT server 105. The members 120-2 and 120-4 and their associated PTT devices 300-2 and 300-4, respectively, are assigned with listener privilege at the PTT server 105. As will be appreciated by a person skilled in the art, lists of members 120-n may be uploaded onto the PTT server 105 to assign members 120-n and their associated PTT devices 300-n with speaker privilege or listener privilege.

After a member has been assigned with speaker privilege, the member may initiate PTT group call sessions and request floor control of a PTT group. Floor control, unless revoked, typically allows the member to speak to the PTT group without being interrupted by other members in the PTT group. As an example, if member 120-1 keys a button of the PTT device 300-1, after being assigned speaker privilege, a request to speak in the PTT session is transmitted to the PTT server 105. If no other users (e.g., member 120-3) are currently speaking in the PTT session, the request is accepted and member 120-1 can then speak to the PTT group. In contrast, listener privilege only allows a member to listen in the PTT group session. Listener privilege does not allow floor control.

For succinctness, members with speaker privilege (i.e., members 120-1 and 120-3) are described herein as “Speakers” and members with listener privilege (i.e., members 120-2 and 120-4) are described herein as “Listeners.”

At block 220, the PTT server 105 receives an authorisation request for a speaker privilege from a Listener. For example, member 120-2 (a Listener) may request a speaker privilege via their PTT device 300-2. In some embodiments, the request for speaker privilege of member 120-2 includes information regarding whether the request is mission critical or non-mission critical. For instance, if member 120-1 is incapacitated or otherwise unable to communicate during a mission and member 120-2 requires speaker privilege to takeover responsibilities for member 120-1, a request to provide speaker privilege to member 120-2 could be considered a mission critical request. In contrast, if member 120-2 merely has reconnaissance information to transmit, a request to transmit such information could be considered a non-mission critical request. In further embodiments, it will also be appreciated that member 120-2 may request that one or more other members (e.g., member 120-4) have a speaker privilege. The speaker privilege of other members may be designated according to a delegation list.

At block 230, the PTT server 105 determines whether authorisation requests are to be determined automatically or manually. If authorisation requests are to be determined automatically, then at block 235 the PTT server 105 automatically determines whether to accept the request.

For example, according to some embodiments, the PTT server 105 may be configured to process an authorisation request to automatically determine whether the request is mission critical or non-mission critical. In response to determining that an authorisation request is mission critical, the PTT server 105 will assign a speaker privilege, such as to the member 120-2. Alternatively, if authorisation requests are to be determined manually, for example, in response to determining that an authorisation request is non-mission critical, at block 240 the authorisation request may be sent to other members, such as members 120-1 and 120-3 (Speakers), for a manual determination of whether speaker privilege should be accepted.

If it is determined at block 235 to accept a request, then at block 260 an automatic mode allows the PTT server 105 to automatically assign a speaker privilege to a member, such as member 120-2.

Alternatively, if at block 230 the PTT server 105 determines that authorisation requests are to be determined manually, then at block 240 a manual mode includes sending the authorisation request to other members, such as the members 120-1 and 120-3 (Speakers), to determine whether speaker privilege should be accepted.

When, at block 240, an authorisation request is sent to other members, e.g., the members 120-1 and 120-3 (Speakers), to determine whether speaker privilege should be accepted, then at block 250, the authorisation request can be accepted or denied by any one of the members 120-1 and 120-3 (Speakers). For example, in response to one of the members 120-1, 120-3 accepting or denying the authorisation request, the PTT server 105 assigns or denies speaker privilege. In further embodiments, acceptance or non-acceptance by any one of members 120-1 and 120-3 is determined according to a seniority list. That is, in response to the authorisation request being sent to members 120-1 and 120-3, a response period commences. During this response period, either member 120-1 or member 120-3 may accept or deny the authorisation request from member 120-2 for speaker privilege. When the response period ends, the server 105 accepts or denies the authorisation request for speaker privilege in accordance with a decision received from the member 120-1, 120-3 having the highest seniority (i.e., the most senior ranked Speaker). In other embodiments, when the response period ends, the server 105 may accept or deny the authorisation request for speaker privilege from the member 120-2 in accordance with a majority preference of the Speakers.

In response to members 120-1, 120-3 accepting, at block 250, the authorisation request from a member such as the member 120-2, at block 260 the PTT server 105 will assign a speaker privilege to the member 120-2. Furthermore, it will be appreciated by a person skilled in the art that in response to members 120-1, 120-3 failing, at block 250, to determine during a given time period whether speaker privilege should be accepted, the PTT server 105 is configured to either assign or deny speaker privilege to member 120-2. Alternatively, if at block 250 the authorisation request of member 120-2 for speaker privilege is denied, member 120-2, if required, may request speaker privilege again at block 220. However, the members 120-1, 120-3 (Speakers) or the PTT server 105 may also suspend further requests for speaker privilege from the member 120-2 for a predetermined period of time as necessary.

At block 260, varying types of speaker privilege may be assigned to member 120-2. For example, a speaker privilege may expire after a predetermined period of time. Alternatively, a member such as the member 120-2 may be assigned with speaker privilege for only a specified number of talk bursts. Further, or additionally, the speaker privilege assigned to the member 120-2 may also be conditional. For example, if member 120-2 is assigned with a conditional speaker privilege, it may allow member 120-2 to request the floor but prevent member 120-2 from accepting requests for speaker privilege from other Listeners (e.g., member 120-4). Further, it will be appreciated by a person skilled in the art that such conditions or functions can be configurable by a particular PTT group.

At block 270, a member such as member 120-2, who was a Listener but has been assigned with a speaker privilege, is allowed floor control to speak to the PTT group. The member 120-2 may be required to request floor control before speaking to the PTT group. However, in further embodiments, it would be appreciated that member 120-2 assigned with speaker privilege may be given floor control automatically. For example, in mission critical requests, the PTT server 105 may assign speaker privilege to member 120-2 and allow the member 120-2 floor control without requiring a request for floor control. Such functionality can be configurable at the PTT server 105.

At block 280, after a Listener, such as member 120-2, is provided with speaker privilege, the speaker privilege is revoked from the member. This may occur automatically or manually. For example, in response to member 120-2 being assigned a speaker privilege for only a specified number of talk bursts, the PTT server 105 will automatically revoke the speaker privilege of member 120-2 when the specified number of talk bursts is reached. Alternatively, if required, members 120-1, 120-3 may, for instance, manually request that the speaker privilege of member 120-2 be revoked. If the speaker privilege of member 120-2 is revoked, the member 120-2 may, if required, request speaker privilege again at block 220.

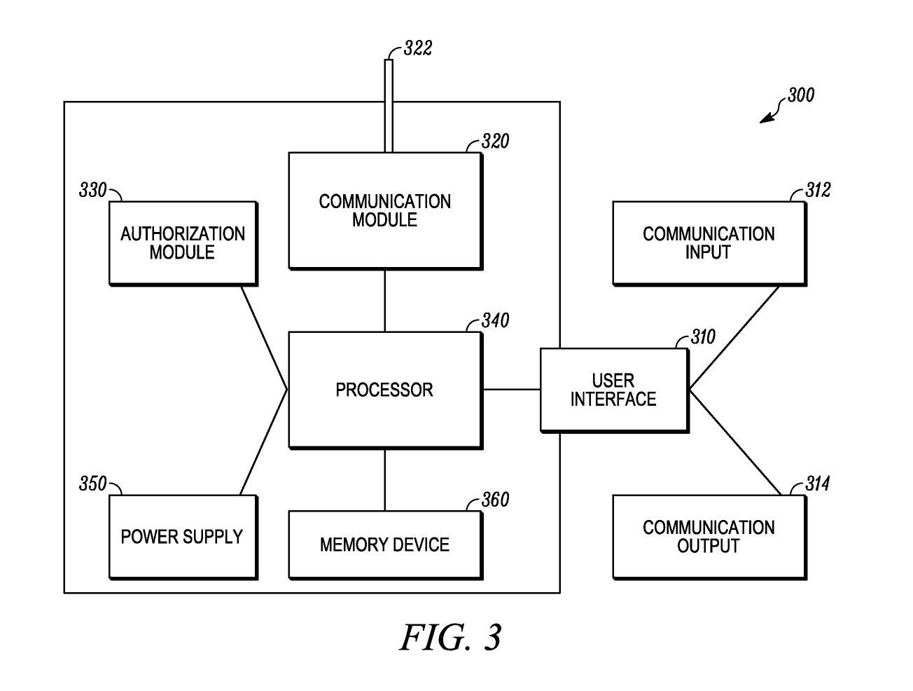

FIG. 3 illustrates a PTT device 300 for controlled talk privilege in a PTT group communication session involving a PTT group, in accordance with some embodiments. For example, the PTT device 300 may correspond to any of the PTT devices 300-n shown in FIG. 1.

The PTT device 300 includes a user interface 310, a transceiver 320, an authorisation module 330, a power supply 350, and a memory device 360 that all are communicatively coupled to a processor 340. Unless otherwise specified, the processor 340 performs the functions described herein as being performed by PTT devices 300-n. The user interface 310 includes a communication input 312 and a communication output 314. In some embodiments, the communication input 312 includes a microphone and push buttons. The communication output 314 includes a speaker and a screen. In further embodiments, it would be appreciated that a touch screen, for example, may form part of the communication input 312 and communication output 314.

The transceiver 320 is coupled to an antenna 322 for wireless communication. The transceiver 320 comprises a receiver (not shown) that is configured to receive communications from the PTT server 105 and/or other PTT devices 300-n in a PTT group and a transmitter (not shown) that is configured to transmit communications to the PTT server 105 and/or other PTT devices 300-n in a PTT group. The transceiver 320 further is configured to receive communication from the user interface 310 and communicate information to the user interface 310 via the processor 340.

The authorisation module 330 is configured to receive and send information to the transceiver 320 and user interface 310. The authorisation module 330 is configured to receive an authorisation request for speaker privilege, via the transceiver 320, from the PTT server 105.

The authorisation module 330 communicates authorisation requests for speaker privilege to members 120-1, 120-3 (Speakers) for approval, via the user interface 310. Members 120-1, 120-3 may then accept or deny the request for speaker privilege, as outlined in method 200 above, through the user interface 310. In some embodiments, members 120-1, 120-3 may navigate through a menu on the display of the user interface 310 to accept or deny a request for speaker privilege. A response to the authorisation request for speaker privilege is then communicated to the PTT server 105, via the transceiver 320. As mentioned previously, members 120-1, 120-3 (Speakers) may assign various types of speaking privilege to other members, such as members 120-2, 120-4 (Listeners). The type of privilege assigned to members 120-2, 120-4, from members 120-1, 120-3, can be selected through the user interface 310.

In further embodiments, when the PTT device 300 is assigned with listener privilege, the authorisation module 330 can be configured to request speaker privilege on demand. In this regard, the PTT device 300 can be configured for use by members 120-n with listener privilege or speaker privilege.

The particular operations/functions of processor 340, and thus of PTT devices 300-n, is determined by an execution of software instructions and routines that are stored in the memory device 360, such as a random access memory (RAM), a dynamic random access memory (DRAM), and/or a read only memory (ROM) or equivalents thereof, that store data and programs that may be executed by the processor. For example, although depicted as separate from processor 340, the authorization module 330 preferably is implemented by processor 340 based on instructions maintained in the memory device 360. The processor 340 also facilitates processing commands between other components in the PTT device 300 (e.g., the user interface 310, transceiver 320, etc.). Furthermore, the power supply 350 powers the PTT device 300. The power supply 350, in some embodiments, can be in the form of rechargeable batteries.

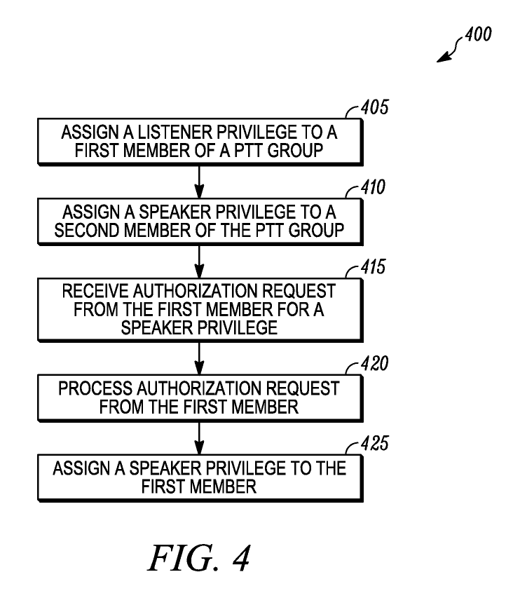

FIG. 4 is a flow diagram illustrating a method 400 for controlled talk privilege in a PTT group communication session involving a PTT group (such as a PTT group comprising members 120-n), according to some embodiments. At block 405, a PTT server, such as PTT server 105, assigns a listener privilege to a first member of the PTT group, wherein the listener privilege allows the first member to listen-only in the PTT group communication session.

At block 410, the PTT server assigns a speaker privilege to a second member of the PTT group, wherein the speaker privilege allows the second member to listen and speak in the PTT group communication session and to receive requests for speaker privilege from members with a listener privilege, and wherein the speaker privilege is a necessary but not sufficient requirement for floor control of the PTT group.

At block 415, an authorisation request is received from the first member, at the PTT server, for a speaker privilege.

At block 420, the authorisation request from the first member is processed, at the PTT server, to determine whether speaker privilege is to be assigned to the first member.

At block 425, in response to an acceptance of the first member's authorisation request for speaker privilege, a speaker privilege is assigned, at the PTT server, to the first member.

As would be appreciated be a person skilled in the art, the wireless communication network 100, the methods 200, 400 for controlled talk privilege in a PTT group communication session involving a PTT group, and the PTT devices 300-n, as described above, have a number of advantages. For example, administration of large talk groups (e.g., groups including thousands of members) is further assisted by designating members 120-n with listener privilege or speaker privilege but, in certain circumstances, members 120-2, 120-4 with listener privilege may be assigned with speaker privilege. This is of particular importance in, for instance, mission critical scenarios where members with speaker privilege (e.g., member 120-1) may be incapacitated or otherwise unable to respond, and members with listener privilege (e.g. member 120-2) require speaker privilege to complete a mission.

The PTT server 105 comprises a processor and a memory device, wherein the functions described herein as being performed by the PTT server are performed by the processor of the PTT server based on an execution of software instructions and routines that are stored in the memory device, such as a random access memory (RAM), a dynamic random access memory (DRAM), and/or a read only memory (ROM) or equivalents thereof, that store data and programs that may be executed by the processor. Further, the PTT server may be configured in a number of ways to automatically accept requests for speaker privilege, automatically accept requests for speaker privilege in mission critical scenarios, send authorisation requests for speaker privilege to members with speaker privilege (e.g. members 120-1 and 120-3) and accept/deny speaker privilege when members with speaker privilege fail to respond. This provides further flexibility in a PTT group communication session.

Allowing different types of speaker privilege to be assigned to members 120-2, 120-4 also improves efficiency in a PTT group communication session. For example, if speaker privilege is only assigned for a number of talk bursts, administrators or members with speaker privilege do not need to concern themselves with revoking the privilege. Rather, privilege is automatically revoked by the server 105 as required.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for controlled talk privilege in a push to talk (PTT) group communication session involving a PTT group, the method including:
assigning, at a PTT server, a listener privilege to a first member of the PTT group, wherein the listener privilege allows the first member to listen-only in the PTT group communication session;
assigning, at the PTT server, a speaker privilege to a second member of the PTT group, wherein the speaker privilege allows the second member to listen and speak in the PTT group communication session and to receive requests for speaker privilege from members with a listener privilege, and wherein the speaker privilege is a necessary but not sufficient requirement for floor control of the PTT group;
receiving an authorisation request from the first member, at the PTT server, for a speaker privilege;
processing the authorisation request from the first member, at the PTT server, to determine whether speaker privilege is to be assigned to the first member; and
in response to an acceptance of the first member's authorisation request for speaker privilege, assigning, at the PTT server, a speaker privilege to the first member.

2. The method of claim 1, wherein the PTT server is configured to automatically accept the first member's authorisation request.

3. The method of claim 1, wherein the PTT server is configured to communicate the first member's authorisation request for speaker privilege to the second member to determine whether speaker privilege should be accepted.

4. The method of claim 3, wherein in response to the second member failing to determine whether speaker privilege should be accepted after a given time period, the first member's authorisation request for speaker privilege is automatically denied by the PTT server.

5. The method of claim 1, wherein the method further includes revoking the speaker privilege of the first member.

6. The method of claim 5, wherein the second member revokes the speaker privilege of the first member via the PTT server.

7. The method of claim 1, further comprising:
wherein the first member is assigned a speaker privilege for only a specified number of talk bursts; and
revoking the speaker privilege of the first member after completion of the specified number of talk bursts.

8. The method of claim 1, further comprising:
wherein the first member is assigned with a speaker privilege for a given time interval; and
revoking the speaker privilege of the first member after completion of the given time interval.

9. A system for controlled talk privilege in a push to talk (PTT) group communication session involving a PTT group, the system including:
a first PTT device;
a PTT server, the PTT server configured to:
receive an authorisation request from the first PTT device for a speaker privilege, wherein the speaker privilege allows the first PTT device to listen and speak in the PTT group communication session, and wherein the speaker privilege is a necessary but not sufficient requirement for floor control of the PTT group;
process the request from the first PTT device to determine whether speaker privilege is to be given to the first PTT device; and
in response to an acceptance of the first member's authorisation request for speaker privilege, assign a speaker privilege to the first member.

10. The system of claim 9, wherein the PTT server is configured to automatically accept the first PTT device's authorisation request.

11. The system of claim 9, wherein the server is configured to communicate the authorisation request from the first PTT device for speaker privilege to a second PTT device to determine whether speaker privilege should be accepted.

12. The system of claim 11, wherein in response to the second PTT device failing to indicate whether speaker privilege should be accepted after a given time period, the first PTT device's authorisation request for speaker privilege is automatically denied.

13. The system of claim 9, wherein the PTT server is configured to revoke the speaker privilege of the first PTT device.

14. The system of claim 13, wherein a second PTT device revokes the speaker privilege of the first PTT device via the PTT server.

15. The system of claim 9, wherein the PTT server is configured to:
assign a speaker privilege to the first PTT device for only a specified number of talk bursts; and
revoke the speaker privilege of the first PTT device after completion of the specified number of talk bursts.

16. The system of claim 9, wherein the PTT server is configured to:
assign a speaker privilege to the first PTT device for a given time interval; and
revoke the speaker privilege of the first PTT device after completion of the given time interval.

17. A push to talk (PTT) device for controlled talk privilege in a push to talk (PTT) group communication session involving a PTT group, the device including:
a user interface face including:
a communication input;
a communication output;
a transceiver that is configured to:
communicate information received from the communication input to a PTT server; and
communicate information received from the PTT server through the communication output; and
a processor that implements an authorisation module, the authorisation module configured to:
receive an authorisation request via the transceiver from another PTT device, via the PTT server, for a speaker privilege, wherein the speaker privilege allows the further PTT device to listen and speak in the PTT group communication session, and wherein the speaker privilege is a necessary but not sufficient requirement for floor control of the PTT group; and
communicate the authorisation request to a user via the user interface; and
provide authorisation through the transceiver for the further PTT device to have speaker privilege, via the PTT server.

18. The PTT device of claim 17, wherein the authorisation module is further configured to send an authorisation request for a speaker privilege through the transceiver to the PTT server.

19. The PTT device of claim 17, wherein the communication received from the user interface includes that the speaker privilege for the further PTT device is only for a specified number of talk bursts.

20. The PTT device of claim 17, wherein the communication received from the user interface includes that the speaker privilege for the further PTT device is only for a given time interval.
